(19) United States
(12) Patent Application Publication
(10) Pub. No.: US 2022/0200429 A1
(43) Pub. Date: Jun. 23, 2022

(54) VIBRATION MOTOR

(71) Applicant: AAC Microtech (Changzhou) Co., Ltd., Changzhou City (CN)

(72) Inventor: Jie Ma, Shenzhen (CN)

(21) Appl. No.: 17/533,141

(22) Filed: Nov. 23, 2021

(30) Foreign Application Priority Data
Dec. 22, 2020 (CN) 202023119581.0

(51) Int. Cl. H02K 33/10; H02K 1/34; H02K 33/18

(52) U.S. Cl. CPC H02K 33/10; H02K 5/04; H02K 33/18; H02K 1/34

(57) ABSTRACT

The present invention provides a vibration motor including an installation housing having a through opening; a vibrator; an elastic member suspending the vibrator; a stator; a magnet; a coil; and a flexible circuit board. The flexible circuit board includes a first conduction part, a second conduction part, and a bending part. The flexible circuit board further includes a position limiting part extending from the bending part and accommodated in the installation housing for abutting against a surface of an inner wall of the installation housing adjacent to the through opening. By virtue of the configuration described in the invention, the assembly accuracy of the vibration motor is ensured.

### FIELD OF THE PRESENT DISCLOSURE

The present disclosure relates to motors, in particular to a vibration motor for providing tactile feedback.

### DESCRIPTION OF RELATED ART

With the development of electronic technology, portable consumer electronic products, such as mobile phones, handheld game consoles, navigation devices, or handheld multimedia entertainment devices, are becoming more and more popular. These electronic products generally use vibration motor for system feedback, such as mobile phone call prompts, navigation prompts, and vibration feedback from game consoles.

A vibration motor comprises an installation housing, a vibrator, a stator, an elastic member and a flexible circuit board. One of the stator and vibrator is provided with a coil, and the other is provided with a magnet. The elastic member suspends the vibrator in the installation housing. One end of the flexible circuit board is located in the installation housing and is connected to the coil, and the other end is connected to the external circuit. Thus realize the conductivity to the coil, and then realize that the vibrator vibrates relative to the stator. However, in the related art, the size of the installation housing drawn by the flexible circuit board is easily out of the traction range because it is not controlled, and the assembly accuracy cannot be guaranteed.

### SUMMARY OF THE PRESENT INVENTION

One of the objects of the present invention is to provide a vibration motor solving the technical problem in the related art that the size of the flexible circuit board pulled out of the installation housing is easily out of the pulling range and further ensuring the assembly accuracy.

To achieve the above-mentioned objects, the present invention provides a vibration motor, comprising: an installation housing having a through opening; a vibrator accommodated in the installation housing; an elastic member suspending the vibrator in the installation housing; a stator fixed to the installation housing for driving the vibrator to vibrate; a magnet engaged with one of the stator and the vibrator; a coil engaged with the other of the stator and the vibrator for interacting with the magnet; and a flexible circuit board corresponding to the through opening.

The flexible circuit board comprises a first conduction part electrically connected to the coil and located in the installation housing, a second conduction part placed outside the installation housing through the through opening, and a bending part extending from the first conduction part and passing through the through opening for connecting with the second conduction part thereby locating between the first conduction part and the second conduction part.

The flexible circuit board further comprises a position limiting part extending from the bending part and accommodated in the installation housing for abutting against a surface of an inner wall of the installation housing adjacent to the through opening.

In addition, a top corner of the position limiting part is far away from the through opening, and a bottom edge of the position limiting part is close to the through opening.

In addition, the position limiting part is parallel to the first conduction part.

In addition, the position limiting part is located on a side of the bending part away from the first conduction part.

In addition, the position limiting part is located on both sides of the bending part.

In addition, the installation housing comprises a housing body with an opening and a cover covering the opening; the housing body includes a first gap, and the cover includes a second gap for cooperatively forming the through opening.

In addition, the second conduction part engages with the cover.

In addition, the position limiting part abuts against the surface of the inner wall of the housing body.

In addition, the vibrator comprises an iron core, a coil wound around the iron core, and a fastener fixed to an end of the iron core; the first conduction part includes a positioning port; and, the fastener comprises a fastening part sheathed in the iron core and a positioning part extending from the fastening part into the positioning port.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an isometric and assembled view of a vibration motor in accordance with an exemplary embodiment of the present disclosure.

FIG. 2 is an exploded and isometric view of the vibration motor in

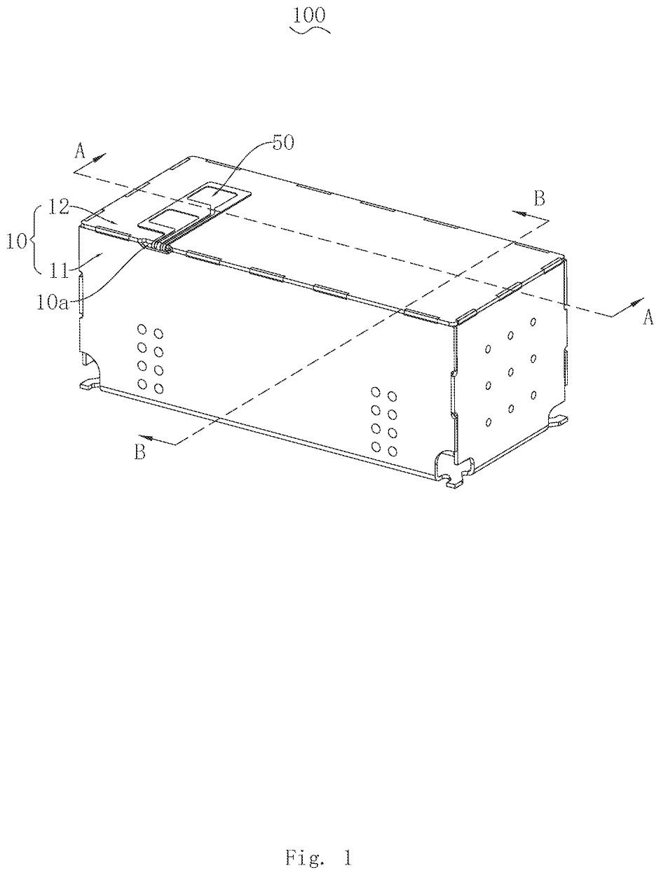

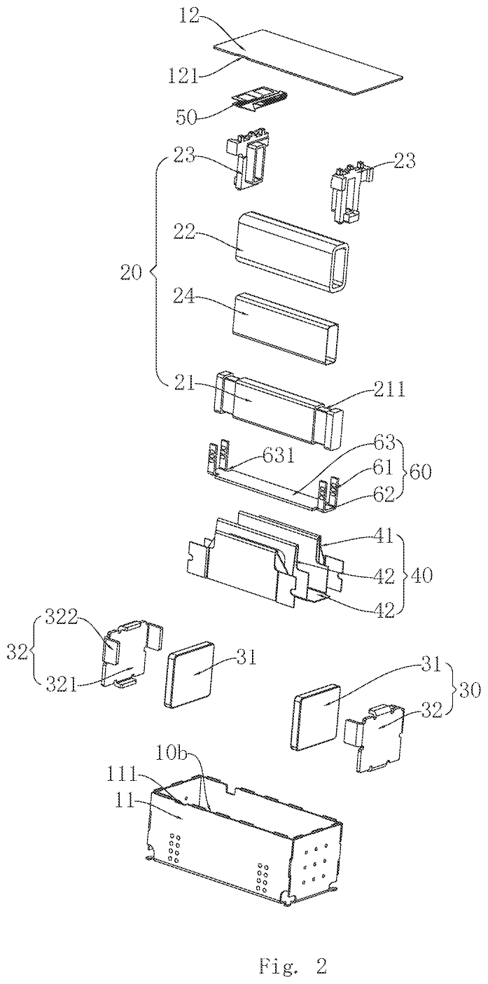

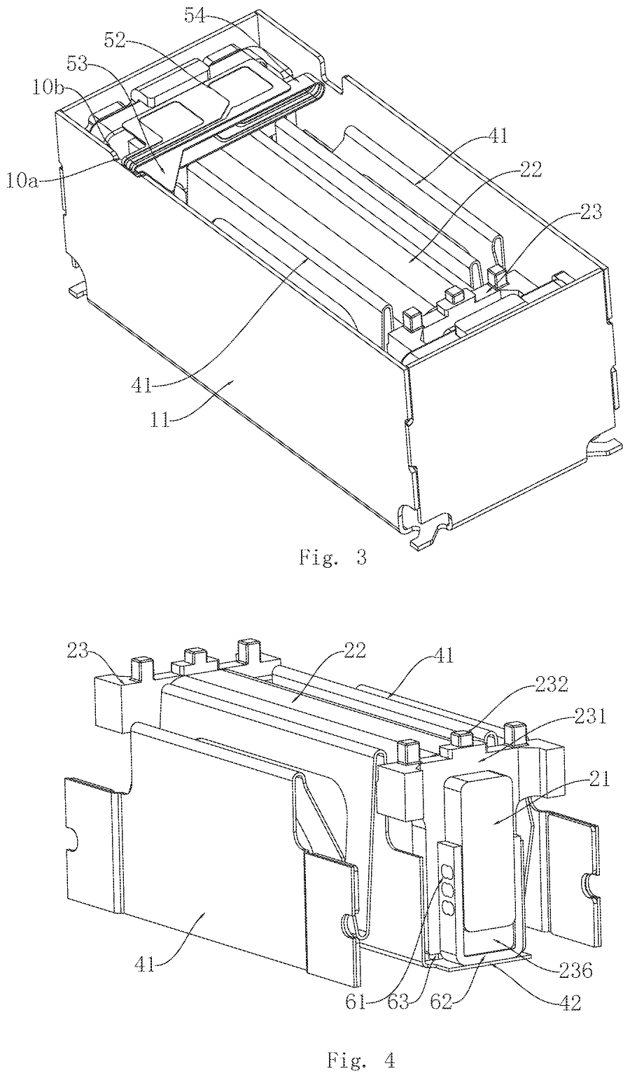

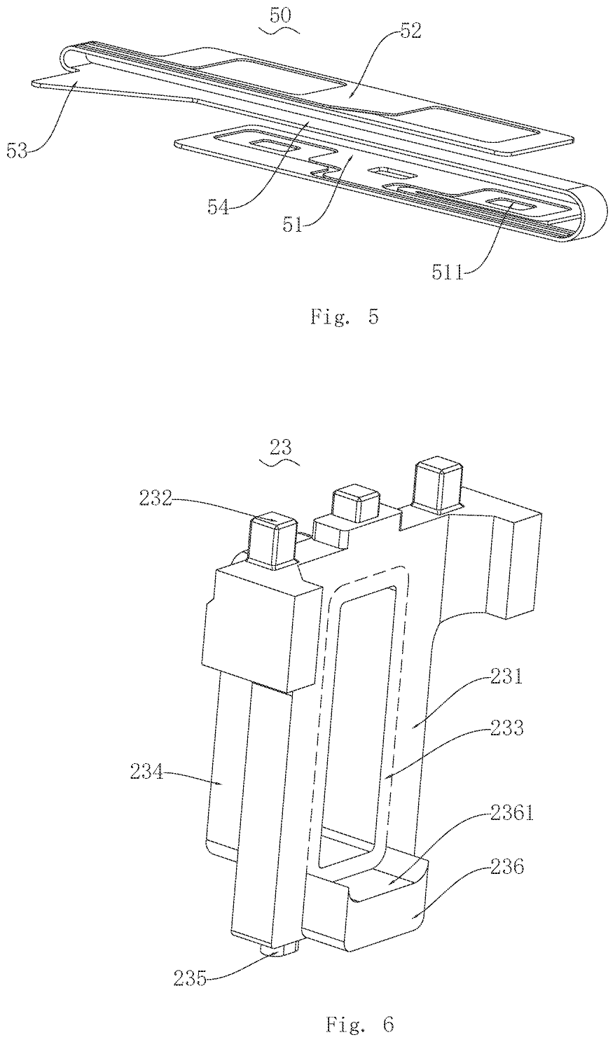

FIG. 1.

FIG. 3 is an isometric and partially assembled view of the vibration motor in FIG. 1.

FIG. 4 is an isometric and partially assembled view of the vibration motor in FIG. 1 with an installation housing thereof removed.

FIG. 5 is an isometric view of a flexible circuit board of the vibration motor.

FIG. 6 is an isometric view of a fastener of the vibration motor.

FIG. 7 is an isometric view of a connection bracket of the vibration motor.

FIG. 8 is a cross-sectional view of the vibration motor taken along line AA in FIG. 1.

FIG. 9 is a cross-sectional view of the vibration motor taken along line BB in FIG. 1.

FIG. 10 is an enlarged view of circled part C in FIG. 8.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby is only to explain the disclosure, not intended to limit the disclosure.

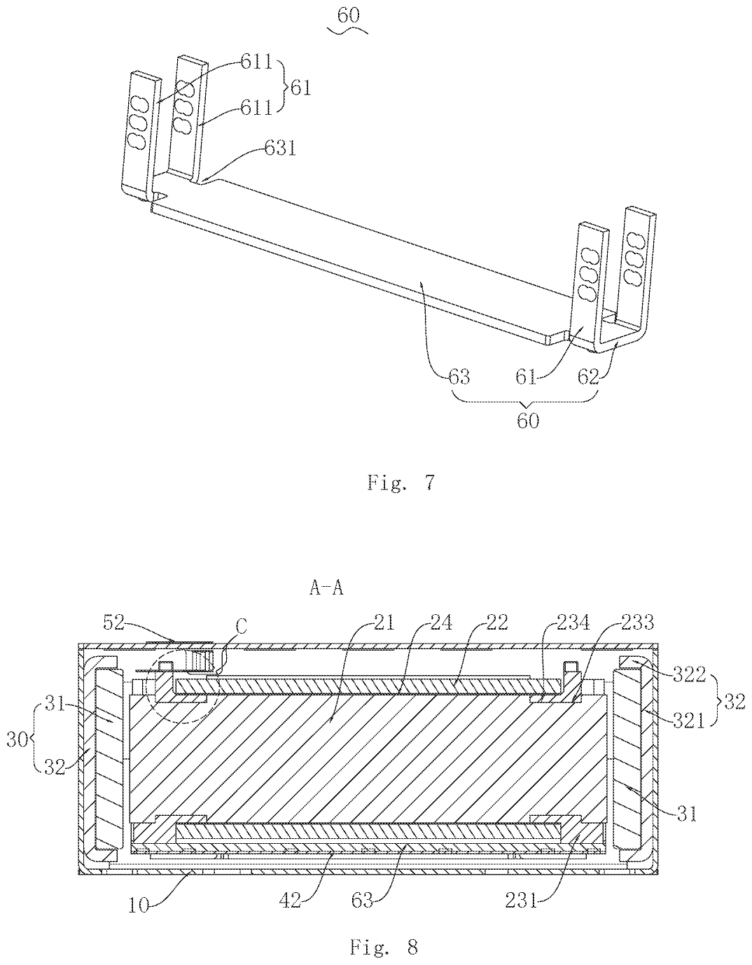

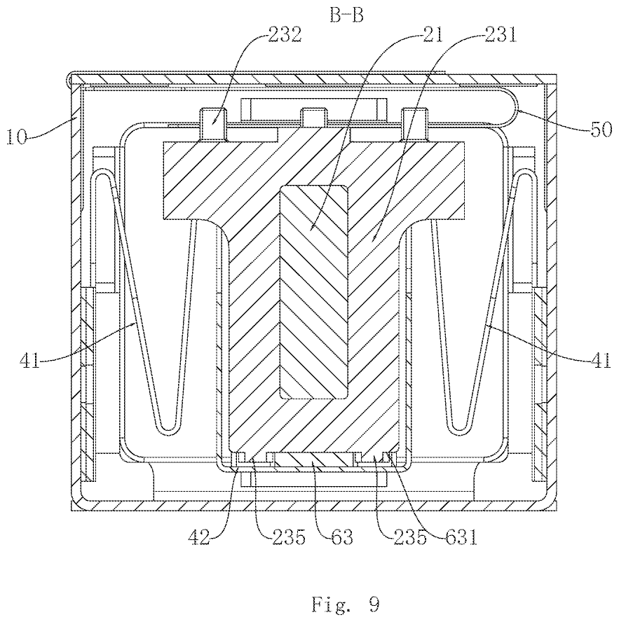

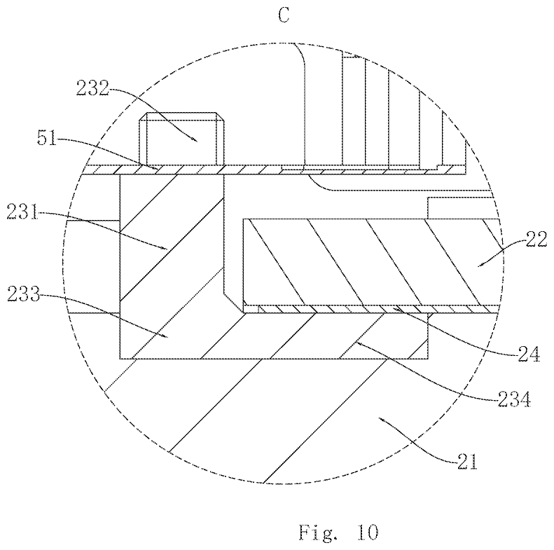

Referring to FIGS. 1-5, a vibration motor 100 comprises an installation housing 10, a vibrator 20 accommodated in the installation housing 10, an elastic member 40 suspends the vibrator 20 in the installation housing 10, and a stator 30 fixed to the installation housing 10 for driving the vibrator 20 to vibrate. One of the stator 30 and the vibrator 20 is provided with a magnet 31, and the other is provided with a coil 22 matching the magnet 31. The vibration motor 100 also comprises a flexible circuit board 50. The installation housing 10 is provided with a through opening 10a corresponding to the flexible circuit board 50. The flexible circuit board 50 comprises a first conduction part 51 that is placed in the installation housing 10 and electrically connected to the coil 22, a second conduction part 52 that is placed outside the installation housing 10 by the through opening 10a, and a bending part 54 connected between the first conduction part 51 and the second conduction part 52. The bending part 54 extends from the first conduction part 51 and passes the through opening 10a to connect with the second conduction part 52. The flexible circuit board 50 also comprises a position limiting part 53 extending from the bending part 54 and accommodated in the installation housing 10. The position limiting part 53 is used to abut the surface of the inner wall 10b of the installation housing 10 adjacent to the through opening 10a.

In the present invention, the flexible circuit board 50 is electrically connected to the coil 22 through the first conduction part 51, and is electrically connected to the external circuit through the second conduction part 52. In this way, the electrical conductivity of the flexible circuit board 50 to the coil 22 is realized. Wherein, the second conduction part 52 realizes its flexible connection with the first conduction part 51 through the bending part 54. Bending part 54 was introduced through opening 10a to place the first conduction part 51 outside the installation housing 10. The position limiting part 53 is formed by the extension of the bending part 54 and is placed in the installation housing 10. When the lead-out range of the second conduction part 52 reaches the limit, the position limiting part 53 abuts on the surface of the inner wall 10b of the installation housing 10 adjacent to the through opening 10a. That is, the position limiting part 53 restricts the lead-out range of the second conduction part 52 relative to the installation housing 10. Using this technical solution solves the technical problem in the prior art that the size of the flexible circuit board 50 pulled out of the installation housing 10 is easily out of the pulling range because it is not controlled, and the assembly accuracy cannot be guaranteed.

In one embodiment, the installation housing 10 comprises a housing body 11 having an opening and a cover 12 covering the opening. The housing body 11 is provided with a first gap 111. The cover 12 is provided with a second gap 121. The first gap 111 and the second gap 121 form a through opening 10a.

Wherein, the second conduction part 52 is fixed on the cover 12. The position limiting part 53 abuts on the inner wall surface 10b of the housing body 11.

It should be noted that the inner wall surface 10b in the present invention specifically refers to the inner surface of the peripheral wall of the housing body 10.

In one embodiment, the position limiting part 53 is a triangular structure to save the material of the flexible circuit board 50. At the same time, the specific direction of position limiting part 53 is set. Wherein, the top angle of position limiting part 53 is far away from through opening 10a. And the bottom edge of the position limiting part 53 is close to the through opening 10a, thereby ensuring the abutment strength and abutment stability of the position limiting part 53.

Preferably, the position limiting part 53 is provided with a right-angled triangle structure.

In one embodiment, the position limiting part 53 and the first conduction part 51 are parallel, so as to avoid spatial interference between the position limiting part 53 and the first conduction part 51. It should be noted that the positional relationship between position limiting part 53 and first conduction part 51 comprises and is not limited to being parallel to each other.

In one embodiment, the position limiting part 53 is located on the side of the bending part 54 away from the first conduction part 51. That is, the position limiting part 53 and the first conduction part 51 are divided into two sides of the bending part 54 to balance the traction force acting on the first conduction part 51.

In addition, in another embodiment, the two position limiting parts 53 are arranged, and the two position limiting parts 53 are located on both sides of the bending part 54. Or, the position limiting part 53 is located on the side of the bending part 54 close to the first conduction part 51.

In some specific embodiments, the first conduction part 51 and the second conduction part 52 are arranged in parallel, or the second conduction part 52 is perpendicular to the first conduction part 51.

With reference to FIG. 8, the vibrator 20 comprises an iron core 21 and a coil 22 wound on the iron core 21. The stator 30 comprises two magnets 31 respectively arranged at both ends of the iron core 21 along the long axis of the iron core 21. When the coil 22 is energized, the vibrator 20 vibrates due to the interaction of the coil 22, the magnet 31, and the iron core 21.

In an embodiment, the stator 30 further comprises a magnetic frame 32 fixed on the installation housing 10 for fixing the magnet 31. The magnetic frame 32 comprises a frame plate 321 and a self-frame board 321 extending toward the magnet 31 and several position limiting claws 322. And several position limiting claws 322 surround magnet 31.

With reference to FIGS. 6, 8 and 10, in an embodiment, the vibrator 20 further comprises a fastener 23 fixed to the end of the iron core 21. The first conduction part 51 is provided with a positioning port 511. The fastener 23 comprises a fastening part 231 sheathed in the iron core 21 and a positioning part 232 extending into the positioning port 511 by the self-fastening part 231. The fastener 23 is set on the iron core 21 through the fastening part 231 to achieve a stable connection with the iron core 21. The positioning part 232 extends into the positioning port 511 of the flexible circuit board 50 to achieve a stable connection with the flexible circuit board 50.

It should be noted that the fastener 23 is made of plastic to achieve insulation from the flexible circuit board 50, iron core 21, and the like. In addition, fasteners 23 can be installed at both ends of the iron core 21.

In one embodiment, in one embodiment, the iron core 21 and the fastener 23 are integrally formed. The iron core 21 and the fastener 23 are integrally molded into a whole. Eliminates the need to assemble the fastener 23 and iron core 21 separately after injection molding. Not only the assembly efficiency is improved, but also the assembly accuracy is ensured.

In one embodiment, the iron core 21 is provided with a clipping slot 211. The fastener 23 also comprises a self-fastening part 231 extending into the clipping part 233 of the clipping slot 211. Clipping part 233 of fastener 23 is inserted into clipping slot 211 of iron core 21. The connection strength between the fastener 23 and the iron core 21 is increased to further ensure the stability of the connection between the fastener 23 and the iron core 21.

In one embodiment, the clipping slot 211 is a circular structure, that is, the clipping slot 211 is arranged along the circumference of the iron core 21. Enhance the connection strength between fastener 23 and iron core 21 with integrity. Correspondingly, the clipping part 233 is a circular structure and is connected to the clipping slot 211 with an adaptable card.

In an embodiment, the vibrator 20 further comprises an insulation film 24 sandwiched between the iron core 21 and the coil 22. That is, insulation film 24 is used for insulation between coil 22 and iron core 21. When the clipping part 233 of the fastener 23 extends into the clipping slot 211 of the iron core 21, the end of the insulation film 24 will not fully wrap the iron core 21, which will lead to poor insulation between the coil 22 and the iron core 21. Therefore, the fastener 23 also comprises an isolation part 234 extending from the clipping part 233 in the direction toward the coil 22. And the insulation film 24 extends to the isolation part 234 when covering the iron core 21 to cover at least part of the isolation part 234, thereby avoiding the contact between the coil 22 and the iron core 21 due to insufficient coating of the iron core 21 at the end of the insulation film 24 the risk of poor insulation is improved, and the reliability between coil 22 and iron core 21 is improved.

In some specific embodiments, the isolation part 234 is flush with the surface of the iron core 21 to maintain the aesthetics when the insulating film covers the iron core 21 and the isolation part 234.

With reference to FIG. 7, in an embodiment, the elastic member 40 comprises two elastic sheets 41 arranged on both sides of the iron core 21 along the long axis of the iron core 21, and two elastic sheets 41 connected between the two elastic sheets 41 and located in the iron core. 21 is the connection sheet 42 on the side away from the flexible circuit board 50. The vibration motor 100 also comprises a connection bracket 60 between the iron core 21 and the elastic sheet 41. Wherein, the connection sheet 42 and the connection bracket 60 are fixedly connected. The fastening part 231 is fixedly connected to the connection bracket 60. The reciprocating motion of the vibrator 20 is realized by two elastic sheets 41 located on both sides of the iron core 21. At the same time, the connection between the two elastic sheets 41 is realized through the connection sheet 42. In addition, the vibration motor 100 also comprises a connection bracket 60 between the iron core 21 and the elastic sheet 41. The connection sheet 42 is fixedly connected to the connection bracket 60. The fastening part 231 is fixedly connected to the connection bracket 60. That is, the elastic member 40 realizes its stable connection with the iron core 21 through the connection bracket 60 and the fastener 23.

Wherein, the connection bracket 60 can be made of high-strength materials such as metal materials.

With reference to FIG. 6, in one implementation, the connection bracket 60 is provided with a clipping opening 631. The fastener 23 also comprises a self-fastening part 231 extending into a clipping position part 235 of the clipping opening 631. The clipping position part 235 of the fastener 23 is snapped into the clipping opening 631 of the connection bracket 60 to position the connection between the connection bracket 60 and the fastener 23. At the same time, the strength of the connection between the connection bracket 60 and the fastener 23 is strengthened.

In an embodiment, the fastener 23 further comprises a placement part 236 formed by extending the self-fastening part 231 toward the end surface of the iron core 21. Placement part 236 is used to support iron core 21. Supporting iron core 21 through placement part 236 not only improves the stability of fastener 23 and iron core 21, but also improves the stability of iron core 21 and connection bracket 60.

In some specific embodiments, the placement part 236 further is provided with a placement groove 2361. The specific shape of the placement groove 2361 is set according to the outer dimensions of the iron core 21 to support the iron core 21 in an adaptive manner.

With reference to FIGS. 4 and 7, in an embodiment, the connection bracket 60 comprises a first connection part 61 connected to the vibrator 20 and a second connection part 62 connected to the elastic member 40. The first connection part 61 of the connection bracket 60 is fixedly connected to the vibrator 20. The second connection part 62 of the connection bracket 60 is fixedly connected to the elastic member 40. Thus, the connection between the elastic member 40 and the vibrator 20 is realized. Using the connection bracket 60 of this technical solution, the connection between the elastic member 40 and the vibrator 20 can be realized quickly and simply. It is not needed to increase the additional structural parts of the elastic member 40. This solves the technical problem of increasing the structural complexity and manufacturing difficulty of the elastic member 40 in order to realize the connection between the elastic member 40 and the vibrator 20.

Wherein, the number of the first connection part 61 and the second connection part 62 are both two, and the two first connection parts 61 are respectively fixed to the two ends of the iron core 21 along the long axis of the iron core 21. Two second connection parts 62 are fixed to the two ends of the elastic member 40 respectively. The two ends of the iron core 21 and the two ends of the elastic member 40 are respectively supported and connected by two first connection parts 61 and two second connection parts 62. Then improve the overall stability of the connection balance between the elastic member 40 and the iron core 21.

In an embodiment, the first connection part 61 comprises two connection arms 611 arranged on both sides of the iron core 21 along the short axis of the iron core 21. The second connection part 62 is connected between the two connection arms 611. Wherein, the second connection part 62 is fixedly connected to the connection sheet 42 of the elastic member 40. The two connection arms 611 of the first connection part 61 are fixed on both sides of the iron core 21 along the short axis of the iron core 21 to improve the connection stability of the connection bracket 60 and the iron core 21. Connect the second connection part 62 between the two connection arms 611. Fix the connection sheet 42 of the elastic member 40 with the second connection part 62, so as to improve the stability of the connection between the connection bracket 60 and the elastic member 40, the reliability of the connection between the elastic member 40 and the iron core 21 is comprehensively improved.

Specifically, the placement part 236 is located between the iron core 21 and the second connection part 62.

In some specific embodiments, the two connection arms 611 and the second connection part 62 is a U-shaped structure. That is, the second connection part 62 is connected between the two ends of the two connection arms 611 with the same direction.

In one embodiment, one end of the connection arm 611 is fixed to the iron core 21, and the other end of the connection arm 611 is fixed to the placement part 236. Connection arm 611 is provided with an iron core 21 and a placement part 236 at the same time, further improving the connection stability between the connection bracket 60, the iron core 21 and the fastener 23.

In an embodiment, the connection bracket 60 further comprises a third connection part 63 connecting the two second connection parts 62. And the third connection part 63 is connected with a connection sheet 42. Through the third connection part 63, the two second connection parts 62 are connected together to realize the integrity of the connection bracket 60 and improve the overall stability of the connection bracket 60. At the same time, through the connection of the third connection part 63 and the connection sheet 42, the connection area between the elastic member 40 and the connection bracket 60 is increased, and the reliability of the connection between the elastic member 40 and the connection bracket 60 is improved.

Specifically, the fastening part 231 is fixedly connected to the third connection part 63 of the connection bracket 60. And clipping opening 631 is opened on the third connection part 63.

In some specific embodiments, the first connection part 61, the second connection part 62 and the placement part 236 are all flush with the end surface of the iron core 21 to improve the assembly aesthetics of the connection bracket 60, the iron core 21 and the fastener 23.

It should be noted that the terms “first” and “second” in the description and claims of the present disclosure and the above-mentioned drawings are used to distinguish similar objects, and not necessarily used to describe a specific sequence or sequence. It should be understood that the data used in this way can be interchanged under appropriate circumstances, so that the embodiments of the present invention described herein can be implemented in a sequence other than those illustrated or described herein, for example. In addition, the terms “comprising” and “having” and any variations of them are intended to cover non-exclusive inclusions. For example, a process, method, system, product, or device that comprises a series of steps or units is not necessarily limited to those clearly listed steps or units. Instead, it may include other steps or units that are not clearly listed or are inherent to these processes, methods, products, or equipment.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A vibration motor, comprising:
an installation housing having a through opening;
a vibrator accommodated in the installation housing;
an elastic member suspending the vibrator in the installation housing;
a stator fixed to the installation housing for driving the vibrator to vibrate;
a magnet engaged with one of the stator and the vibrator;
a coil engaged with the other of the stator and the vibrator for interacting with the magnet;
a flexible circuit board corresponding to the through opening, comprising a first conduction part electrically connected to the coil and located in the installation housing, a second conduction part placed outside the installation housing through the through opening, a bending part extending from the first conduction part and passing through the through opening for connecting with the second conduction part thereby locating between the first conduction part and the second conduction part; wherein
the flexible circuit board further comprises a position limiting part extending from the bending part and accommodated in the installation housing for abutting against a surface of an inner wall of the installation housing adjacent to the through opening.

2. The vibration motor as described in claim 1, wherein a top corner of the position limiting part is far away from the through opening, and a bottom edge of the position limiting part is close to the through opening.

3. The vibration motor as described in claim 2, wherein the position limiting part is parallel to the first conduction part.

4. The vibration motor as described in claim 3, wherein the position limiting part is located on a side of the bending part away from the first conduction part.

5. The vibration motor as described in claim 3, wherein the position limiting part is located on both sides of the bending part.

6. The vibration motor as described in claim 1, wherein the installation housing comprises a housing body with an opening and a cover covering the opening; the housing body includes a first gap, and the cover includes a second gap for cooperatively forming the through opening.

7. The vibration motor as described in claim 6, wherein the second conduction part engages with the cover.

8. The vibration motor as described in claim 7, wherein the position limiting part abuts against the surface of the inner wall of the housing body.

9. The vibration motor as described in claim 1, wherein the vibrator comprises an iron core, a coil wound around the iron core, and a fastener fixed to an end of the iron core; the first conduction part includes a positioning port; and, the fastener comprises a fastening part sheathed in the iron core and a positioning part extending from the fastening part into the positioning port.
